(19) United States
(12) Patent Application Publication
(10) Pub. No.: US 2006/0282788 A1
(43) Pub. Date: Dec. 14, 2006

(54) System and method for creating and utilizing context-sensitive popularity data

(75) Inventors: Joonas Paalasmaa, Helsinki (FI); Markus Aspiala, Jarvenpaa (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/149,630

(22) Filed: Jun. 10, 2005

(51) Int. Cl. G06F 9/00

(52) U.S. Cl. 715/764

(57) ABSTRACT

A system and method for preprocessing context-sensitive content on an electronic device. A plurality of properties are monitored for a plurality of files. A probability is determined for each of the plurality of files regarding whether each particular file will be accessed by a user when the user is browsing a particular location on an electronic device in a particular context. When the user browses to the particular location, those files that were calculated to possess the highest probability of being opened at the particular location in the particular context of the device are preprocessed, enabling the user to quickly access the files.

### FIELD OF THE INVENTION

The present invention relates generally to the navigation of content on electronic devices. More particularly, the present invention relates to the identification and preprocessing of content items on electronic devices in order to improve the browsing of content.

### BACKGROUND OF THE INVENTION

Navigation in applications for mobile telephones and other devices usually involves the selecting of content from a list in order to view the content. In such applications, the list is quickly displayed to the user with little delay. This is due to the fact that metadata can usually be fetched very quickly from a database. However, once an item in the list has been selected, it can take a significantly longer period of time to open the actual content. The reason for this longer delay is that the opening and processing of large files is usually required before the content can be fully displayed.

Advanced image manager applications such as the Nokia Album application (which can be found at www.nokia.com/imaging/album), provide users with a smooth browsing experience. Such programs can very quickly fetch thumbnails and metadata of images from a database. When the file is actually opened, however, it takes some seconds before the file can be displayed, because reading the file from the memory card and processing the file takes time.

Many personal computer applications include adaptive lists whose order is determined by the user's actions. In such applications, the adaptive lists can be set and organized based upon the most recently or most frequently accessed. However, these lists typically do not reflect the context in which the user is currently operating. Instead, the lists are usually general in nature.

### SUMMARY OF THE INVENTION

The present invention provides a system and method for accelerating the browsing of items such as images on devices such as mobile telephones. According to the present invention, content items that the user will most likely open in a certain situation are preprocessed. The probability that an image will be opened in a certain usage context can be calculated from the image properties, the usage context, data about the user's browsing history, and other factors. These probabilities can be continuously updated, as the user's navigation within the user interface will affect the probability that a particular file will be opened. Due to the limited capacity in some devices, only the items that are most likely to be opened can be maintained in the easily-accessible memory according to one embodiment of the invention, while items that are less likely to be opened are either discarded or moved to less easily-accessible memory.

With the present invention, the user experience can be enhanced in image management applications. In the image management context, individual images can be accessed by the user much more quickly than in conventional systems, and user navigation is greatly improved. The present invention can also be used with files other than image files, permitting these benefits to be achieved in other situations as well.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a mobile telephone that can be used in the implementation of the present invention;

FIG. 2 is a schematic representation of the telephone circuitry of the mobile telephone of FIG. 1;

FIG. 3 is a flow chart showing the implementation of one embodiment of the present invention; and

FIG. 4 is a representation of an image list generated and exhibited according to one embodiment of the present invention.

### DETAILED DESCRIPTION OF THE INVENTION

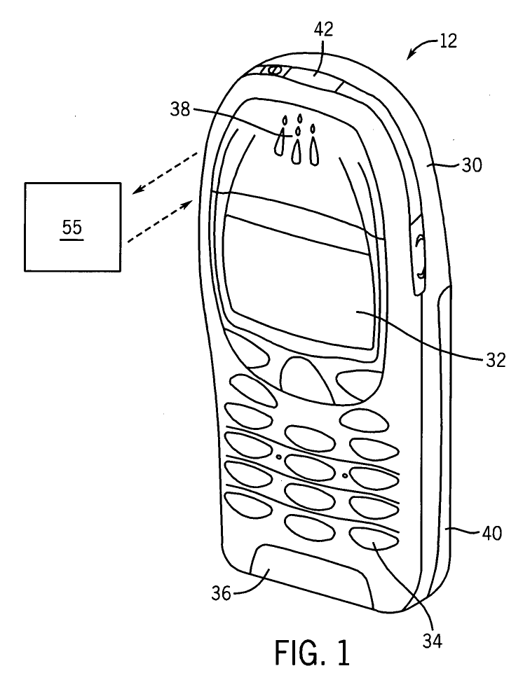

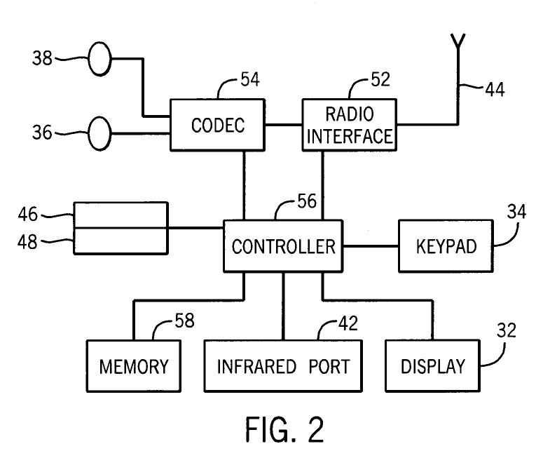

FIGS. 1 and 2 show one representative mobile telephone 12 within which the present invention may be implemented. It should be understood, however, that the present invention is not intended to be limited to one particular type of mobile telephone 12 or other electronic device. For example, the present invention can be incorporated into a personal digital assistant (PDA), a combination PDA and mobile telephone, an integrated messaging device (IMD), a desktop computer, or a notebook computer. The device into which the present invention is incorporated may be stationary or mobile, as when carried by an individual who is moving. The device may also be located in a mode of transportation including, but not limited to, an automobile, a truck, a taxi, a bus, a boat, an airplane, a bicycle, a motorcycle, etc. The device may send and receive calls and messages and communicate with service providers through a wired or wireless connection to a larger network.

The mobile telephone 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention provides for an improved method and system for locating and accessing particular images or files on an electronic device. According to the principles of the present invention, the probability that a particular image or other file will be opened in a certain usage context in an image or file management application can be calculated by applying probability calculus methods to (1) the properties of each file, (2) the usage context, and (3) data regarding the user's browsing history. Other properties can also be considered depending upon the particular system and properties available. By utilizing probability data, the browsing of content can be accelerated by preprocessing content items that the user will most likely open in a certain situation. The availability of context-sensitive probability data enables the creation of usage context-sensitive favorite lists, where the most popular images or files for viewing in an image or file management application are listed.

Image management applications can provide a strong platform for implementing the present invention, because such applications provide data that can be used to calculate the probabilities of opening particular images. However, the present invention can be used in conjunction with a wide variety of applications and is not limited to image-related applications. It should also be noted that the present invention is not limited solely to the management of image files. The present invention can be used with a wide variety of files, including but not limited to audio files, video files, electronic mail and other files. The present invention can also be used with digital content in any form, such as SMS messages that are pieces of data instead of a whole file. Furthermore, it is not necessary that all of the files being managed according to the present invention be of the same type; some files may be image files, while others may be video files, electronic mail, etc.

In an image management context, the probability that an image will be opened can be calculated by comparing the browsing situation or context with the user's browsing history. For example, if the user always opens a certain image in a given context, such as at a certain time of day, it can be deduced that the user will open the image again when the same particular context arises. Apart from attempting to determine which individual images will likely be opened in a given context, it can also be deduced the type of properties that the likely-to-be-opened images will possess.

Properties for an image that can be taken into account in calculating the probability that a particular image will be opened include, but are not limited to (1) the unique identifier of an image; (2) the location where the image was captured; (3) patterns recognized within the image; (3) collection information, keywords and similar metadata; (4) the origin of the file; (5) the creator/author of the file; and (6) the file type.

The browsing context can be constructed from various properties surrounding the browsing situation. For example, the browsing context can be based upon the individual who is viewing the images, the time and/or date when the viewing occurs, recently viewed images, the physical location of where the image is being viewed, sensor metadata, and others. For the location of viewing, additional information can be extracted for that particular location. For example, the system can observe the image collection that is most frequently accessed in that location, as well as images that may have been captured in that location in the past. For sensor metadata, factors that can be considered include whether the viewing occurs indoors or outdoors, whether the environment is loud or quiet, and the ambient temperature. This information can be obtained through the use of audio sensors, visual sensors or other sensors on the device at issue. This information can also be gathered from other sources. For example, if ambient temperature is to be used as a factor, the device could contact a remote server that includes current weather information for the device's location.

The probability that an image will be opened in a given context can be calculated from the image properties, the usage context, and data about the user's browsing history. Using one of a variety of statistical methods, such as Bayesian statistics, a probability for each image can be determined. The probability calculations can be further enhanced by taking into account a general popularity value for each image. The number of browsing steps that are required to reach an image can also be considered. For example, if a user must navigate through several menus in order to reach the image, then it may be very unlikely that the image would be accessed in a certain situation.

Once the probabilities have been calculated, the items that are most likely to be opened can be preprocessed and preloaded into easily accessible memory. Because a device's memory capacity is not unlimited, every content item cannot always be kept in the most easily-accessible memory. As the probabilities of various items being opened change, only the items most likely to be opened can be kept in this location. Items less likely to be opened can be discarded or left in less easily-accessible memory.

In one embodiment of the invention, the calculated probabilities are updated on a regular basis or continuously. This can be desirable because usage statistics will change as a user continues to navigate in the user interface, which will ultimately affect the calculated probabilities.

In another embodiment of the present invention, the probability calculations can also be used to create context-sensitive favorite lists for each view in an application such as an image management application. In this embodiment of the invention, the favorite lists can contain the most popular items for each view in the application. For example, in a photo album, the most popular images for the entire album can be preloaded and displayed on the primary “gateway” screen for the application, while inside particular albums, the most popular images for that album can be preloaded and exhibited.

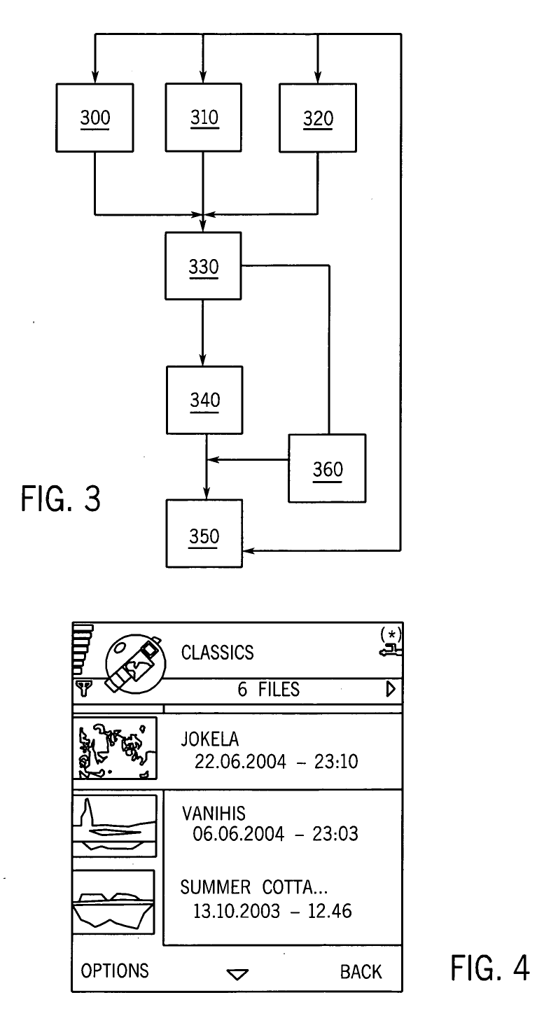

FIG. 3 is a flow chart showing the process for implementing one embodiment of the present invention. As shown in FIG. 3, a device into which the present invention is incorporated monitors the properties of a plurality of files at 300, the usage context of each of the plurality of files at 310, and data regarding the user's browsing history at 320. These properties can be monitored either simultaneously or sequentially. Other factors can also be monitored. At step 330, the information monitored at steps 300-320 is used to generate a probability that each file will be opened from a given screen in an application in a particular context. At step 340, the user maneuvers through the user interface of his or her device to the particular screen at the particular context. At step 350, the files that are determined to be most likely to be opened by the user in that context are preprocessed, and the files can be preloaded and exhibited to the user if so desired. The preprocessing can take a variety of forms. For example, if a particular icon is likely to be actuated, then that particular icon can be enlarged on the display 32, or change color. Other types of real time prioritization could also be performed. This process can then be regularly or continuously repeated while incorporating the user's most recent activities. An optional step 360 can also be used to create a context-specific favorite list based upon the probability information gathered at step 330. An example list of high-probability files is shown in FIG. 4 and can be exhibited to a user after preprocessing.

In one particular embodiment of the present invention, the mobile telephone 12 or other electronic device can connect to a remote server, represented at 55 in FIG. 1, in a secure manner using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, and others. Using these types of communication methods, the mobile telephone 12 or other device can access a remote database in order to gather information to be used in the probability determinations. For example, a user's mobile telephone 12 can access a user's own user profile in order to determine the frequency at which particular image files were accessed by the user on his or her personal computer, personal digital assistant, or other devices. Such a procedure can involve the use of a database within the server 55 or in another device that is communicatively connected to the server 55.

In one embodiment of the invention, such as where the mobile telephone 12 or other device is operating in a high-speed, always connected 3G environment, the mobile telephone 12 does not have to maintain any file information locally in the device, except when individual files are preloaded. Instead the files can be maintained remotely, and all data parsing can be performed in the server environment. The mobile telephone 12 or other device can then retrieve the probability information and the files to be preprocessed and preloaded through a network connection using a proprietary protocol. This particular embodiment of the invention further removes the burden of storing additional information in the device at issue and forcing the device to parse through the information as the device's complexity grows.

The present invention can also be applied to a situation where a high-quality version of a content item is stored on a remote device such as a server 55. The present invention can be used to identify the likelihood that this content item will be requested by a user in a certain situation. If the situation arises, the mobile telephone 12 or other device can then cache a copy of the content item locally for quicker access.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of preprocessing content on an electronic device, comprising:
monitoring a plurality of properties regarding a plurality of files;
for the plurality of files, determining a probability that the file will be accessed by a user when the user is browsing a particular location on an electronic device in a particular context; and
upon the user browsing the particular location, processing files from the plurality of files that have the highest probability of being opened at the particular location in the particular context.

2. The method of claim 1, further comprising displaying the files that have the highest probability of being opened at the particular location to the user in the particular context when the user browses the particular location in the particular context.

3. The method of claim 1, wherein each of the plurality of files comprise an image.

4. The method of claim 3, wherein the plurality of properties for each file are selected from the group consisting of a unique identifier for the image, the location where the image was captured, patterns recognized from the image, metadata associated with the image, the origin of the image, the creator of the image, the file type and combinations thereof.

5. The method of claim 1, wherein the plurality of files further comprises digital content in any form.

6. The method of claim 5, wherein the plurality of files comprise files selected from the group consisting of audio files, video files, image files, electronic mail, and combinations thereof.

7. The method of claim 1, further comprising preloading the files that have the highest probability of being opened at the particular location to the user in the particular context when the user browses the particular location in the particular context.

8. The method of claim 1, wherein the context is based upon the group consisting of those individuals who open the file, the time at which the file is opened, the date at which the file is opened, recently accessed files, metadata gathered from sensors on the electronic device, the location of the device when the file is accessed, and combinations thereof.

9. The method of claim 1, wherein the probability for each of the plurality of files is generated using Bayesian statistics.

10. The method of claim 1, wherein the plurality of properties include the relative popularity of each file.

11. The method of claim 1, wherein the plurality of properties include the number of steps required for the user to access the file from the particular location.

12. A computer program product for preloading content on an electronic device, comprising:
computer code for monitoring a plurality of properties regarding a plurality of files;
computer code for, for the plurality of files, determining a probability that the file will be accessed by a user when the user is browsing a particular location on an electronic device in a particular context; and
computer code for, upon the user browsing the particular location, processing files from the plurality of files that have the highest probability of being opened at the particular location in the particular context.

13. The computer program product of claim 12, wherein each of the plurality of files comprise an image.

14. The computer program product of claim 13, wherein the plurality of properties for each file are selected from the group consisting of a unique identifier for the image, the location where the image was captured, patterns recognized from the image, metadata associated with the image, the origin of the image, the creator of the image, the file type and combinations thereof.

15. The computer program product of claim 12, wherein the plurality of files comprise files selected from the group consisting of audio files, video files, image files, electronic mail, and combinations thereof.

16. The computer program product of claim 12, further comprising computer code for preloading the files that have the highest probability of being opened at the particular location to the user in the particular context when the user browses the particular location in the particular context.

17. The computer program product of claim 12, wherein the context is based upon the group consisting of those individuals who open the file, the time at which the file is opened, the date at which the file is opened, recently accessed files, metadata gathered from sensors on the electronic device, the location of the device when the file is accessed, and combinations thereof.

18. The computer program product of claim 12, wherein the probability for each of the plurality of files is generated using Bayesian statistics.

19. The computer program product of claim 12, wherein the plurality of properties include the relative popularity of each file.

20. The computer program product of claim 12, wherein the plurality of properties include the number of steps required for the user to access the file from the particular location.

21. An electronic device, comprising:
a processor; and
a memory operatively connected to the processor and including:
computer code for monitoring a plurality of properties regarding a plurality of files;
computer code for, for the plurality of files, determining a probability that the file will be accessed by a user when the user is browsing a particular location on the electronic device in a particular context; and
computer code for, upon the user browsing the particular location, processing files from the plurality of files that have the highest probability of being opened at the particular location in the particular context.

22. The electronic device of claim 21, wherein each of the plurality of files comprise an image.

23. The electronic device of claim 22, wherein the plurality of properties for each file are selected from the group consisting of a unique identifier for the image, the location where the image was captured, patterns recognized from the image, metadata associated with the image, the origin of the image, the creator of the image, the file type and combinations thereof.

24. The electronic device of claim 21, wherein the context is based upon the group consisting of those individuals who open the file, the time at which the file is opened, the date at which the file is opened, recently accessed files, metadata gathered from sensors on the electronic device, the location of the device when the file is accessed, and combinations thereof.

25. The electronic device of claim 21, wherein the electronic device comprises a mobile telephone.

26. The electronic device of claim 21, wherein the plurality of files comprise files selected from the group consisting of audio files, video files, image files, electronic mail, and combinations thereof.

27. The electronic device of claim 21, wherein the memory unit further comprises computer code for preloading the files that have the highest probability of being opened at the particular location to the user in the particular context when the user browses the particular location in the particular context.
